(19) United States
(12) Patent Application Publication
(10) Pub. No.: US 2004/0226968 A1
(43) Pub. Date: Nov. 18, 2004

(54) Nozzle for dispensable viscous materials

(76) Inventor: Luc Marcel Lafond, Etobicoke (CA)

Correspondence Address: SMITH, GAMBRELL & RUSSELL, LLP, SUITE 3100, PROMENADE II, 1230 PEACHTREE STREET, N.E., ATLANTA, GA, 30309-3592, US

(21) Appl. No.: 10/793,180

(22) Filed: Mar. 4, 2004

Related U.S. Application Data
(60) Provisional application No. 60/451,281, filed on Mar. 4, 2003.

(51) Int. Cl. G01F 11/06

(52) U.S. Cl. 222/327; 222/389

(57) ABSTRACT

A nozzle is used in a hand held dispenser of viscous fluid including caulking, sealant or adhesive. The nozzle has an elongated body that extends along a longitudinal axis, defining a fluid path extending between a dispensing end and a base. The base includes a coupling to secure the nozzle to a dispensing device or to a container of the viscous fluid. The nozzle includes a variable flow valve that operates through a range of positions, between a fully closed position and a fully open position. The valve operates within a housing that extends across the longitudinal axis of the body. A second coupling connects the valve to a hand control on the dispenser. Preferably, the valve rotates between the closed and open positions. The nozzle is also included in a dispensing gun. The dispensing gun includes a hand activated control on the gun handle. The control operates the valve between the closed and open positions and co-acts to urge the fluid contents of the dispensing gun to flow through the nozzle. A kit for a nozzle assembly in a hand held dispenser includes the nozzle and a replaceable nozzle tip. The kit may also include one or more interchangeable nozzle tips, a replaceable end cap, and a cleaning tool for the nozzle.

### CROSS-REFERENCE TO RELATED APPLICATION

This application claims the benefit of U.S. provisional patent application No. 60/451,281, filed Mar. 4, 2003 entitled “Nozzle for Dispensable Viscous Materials”.

### FIELD OF THE INVENTION

The following invention relates to nozzles for use in connection with dispensable viscous materials, including sealants, lubricants, pastes, epoxies, and other viscous materials. By way of an example, caulking guns, grease guns and other dispensers for viscous materials may be used in connection with nozzles of the present invention. The nozzles of the invention will have application in various commercial, construction and industrial applications in which viscous materials will be dispensed.

### BACKGROUND

Dispensable, viscous materials such as adhesives, epoxies, sealants, including caulking, pastes, lubricants, and other viscous materials are typically packaged in rigid, thermoplastic tubular containers, or spiral bound cardboard tubes. To some extent, although not as often, some of these viscous materials come pre-packaged in tubular, sausage type containers having a relatively strong, but flexible outer impermeable skin to encapsulate the viscous material.

The rigid containers are often provided with pre-attached nozzle tips made from a thermoplastic material that is sealed against entry of air and to prevent the viscous material from escaping from the container. An air seal may be provided between the main portion of the tube containing the viscous material, and the base of the hollow nozzle tip. A user will typically cut away a portion of the nozzle tip, to create an opening to dispense the viscous material, and then will pierce the air seal (through the newly created opening), so that when in use, the viscous material will enter the channel of the hollow nozzle and exit from the cut opening at the nozzle tip. The user will then try to carefully apply sufficient pressure to the contents of a caulking gun or other dispensing device to apply a uniform bead of material to a target surface. The inability to apply to uniform bead is a common problem associated with hand operated caulking guns, and powered dispensers fitted with conventional nozzles, including aerosol containers filled with dispensable materials such as caulking or other sealants.

Unfortunately, it is relatively difficult for inexperienced users and many trained workers to apply uniform beads of material over extended periods of time. Conventional hand controls are prone to significant variations in bead quality and appearance. Even if an operator is provided with a powered dispensing device, it is difficult for the operator to control the flow rate at which the viscous material is dispensed and deposited to a target area.

One of the most common types among existing tubular container designs includes the fixed, hollow nozzle tip made from polyethylene or other thermoplastic material, briefly described above. The nozzle tip is fixed to the container, and if it is spoiled, plugged, or rendered unusable, the entire container must be thrown away because the user will not have a convenient, cost effective replacement for the spoiled nozzle tip. Furthermore, existing nozzles are not provided with replaceable or interchangeable nozzle tips. Essentially, a user is not provided with a selection of interchangeable tips that could be used to dispense different shapes and sizes of beads.

There are many other disadvantages to using known conventional nozzle designs. By way of further example, but not by way of limitation, prefixed nozzles cannot be removed for cleaning and cannot be reused. Once the container is emptied, the container and the nozzle tip are discarded. There are also other disadvantages associated with prefixed nozzles in that the overall container size is greatly increased by the added length of the prefixed nozzle component. The added length makes it necessary for manufacturers and others to package the containers in relatively large boxes to accommodate the added space occupied by the nozzles. If the nozzle of a container is damaged during shipping or handling, the entire damaged container and its contents are typically discarded, resulting in significant losses and higher costs. Earlier nozzle designs of this type are not readily adaptable for use in dispensing viscous materials from sausage type containers. Furthermore, these conventional nozzle designs do not provide features to control the flow rate for dispensing the viscous materials from lightweight hand held dispensing devices, including caulking guns.

### SUMMARY OF THE INVENTION

The present invention is adaptable for use with a wide variety of dispensing devices, including hand portable caulking guns, grease guns, dispensers for other viscous materials, including foodstuffs. The invention may also be applied for use with handheld devices that may be powered by stationary compressors or battery powered portable air compressors, electrically powered hand tools and other dispensing devices. Although certain examples and embodiments of the invention will be explained in connection with caulking guns and hand held portable devices, the invention may be used in association with many other devices and other equipment for dispensing viscous materials.

In one aspect, the invention is a nozzle assembly having a hollow body. The body includes a base that can be secured, fastened or operatively associated for fluid communication with a container for a dispensable viscous material. Preferably, the nozzle assembly is secured to the container or to a dispensing device for the container, to avoid seepage or escape of the viscous material. In certain embodiments, the nozzle assembly will not be secured or fixed to either piece, but will be positioned in a manner that will direct flow of the viscous material from the container to the tip of the nozzle assembly. The body of the nozzle assembly defines a housing for a valve gate. The gate operates between a first (fully open) position, and a second (fully closed) position. The gate may also be positioned in a range of positions between the first and second positions, to provide a variable flow rate of viscous material through the nozzle assembly. The valve gate may be a rotating spindle, a sliding gate, or other structure capable of providing a range of openings between fully open and fully closed positions.

In another aspect, the nozzle assembly is detachable from the container or dispensing device. In a preferred embodiment, the base of the nozzle assembly is attached to the container (or to a dispensing device). Although the base may also be detachable from the container (or dispensing device), the assembly includes a detachable nozzle tip which is attached to the base for operation, and is detached from the base, for replacement with another interchangeable tip, or for storage. An optional reclosure cap may also be provided. The reclosure cap may be provided with two portions. A first portion of the reclosure cap may be used to cover the opening of the nozzle tip piece, and a second portion of the reclosure cap may be used to cover an opening on the base of the nozzle assembly.

In another aspect, the detachable nozzle tip may be interchangeable with one or more nozzle tips capable of dispensing beads of different shapes and sizes.

In yet another aspect of the invention, the nozzle assembly may be provided with a feature to mount the nozzle assembly for use in connection with a conventional container such as a caulking tube, sausage or other conventional container including a conventional, prefixed nozzle piece. The existing nozzle piece may be trimmed or cut away, to leave a mounting stem. The nozzle assembly may be secured to the remaining stem, or may be operatively associated in some other way with the container for fluid communication between the container contents and the nozzle assembly.

In certain embodiments of the invention, a tapered interior fluid channel is defined by the interior of the nozzle assembly, including an alignable opening in the valve gate, so that a continuous, tapered channel is provided along the longitudinal axis of the assembly, extending from the base of the assembly to the dispensing end. A simple, reusable or disposable cleaning tool with a matching taper may be used to clean the channel after use.

Although many embodiments of the invention may be manufactured from relatively inexpensive and lightweight materials, for disposal after a single use, other embodiments may be made from other materials, for prolonged or repeated use, where it is desirable to do so.

In another aspect, the invention includes a kit for installation of a nozzle assembly of the present invention. For example, a cartridge containing viscous material may include a mount to which it will be possible to secure the necessary components of a nozzle assembly. The kit may also include one or more replaceable nozzle tips, or other components such as O-rings, seals or adaptors, such as, but not limited to, an adaptor cap for use with sausage-type containers. An optional cleaning tool may also be included in the kit.

In another aspect of the invention, the nozzle assembly (or components of the nozzle assembly, such as the nozzle base) will come fixed to the container for viscous material. In other instances, durable, wear resistant components of the assembly may come fixed to the dispensing device, as part of an OEM dispensing device. Some or all of the components in the nozzle assembly may be replaceable.

The nozzle assembly of the present invention provides a variable flow nozzle which may be used to replace securely fastened, conventional nozzles on pre-packaged dispensable materials such as caulking, adhesives and other viscous, flowable materials. In other instances, the nozzle assembly of the present invention may be used to replace nozzle components which are incapable of controlling flow through a nozzle tip.

The nozzle assembly of the present invention may provide one or more of the following advantages or other advantages which will become apparent upon a review of the present specification. By way of an example, one or more of the following advantages may be obtained:

a re-attachable, reusable nozzle assembly may be used to replace a pre-attached nozzle which is incapable of dispensing material at a variable flow rate.

a nozzle assembly may be fully interchangeable with other nozzle components to provide variations in flow volumes, patterns and extruded bead sizes.

a nozzle assembly may be provided with a plurality of interchangeable nozzle tips.

a nozzle assembly may be provided with a reclosure cap having one or more cap portions. A first cap portion may be provided to cover an opening of one portion of the nozzle assembly. A second cap portion can be used to cover a second opening.

the valve gate may be configured in a variety of ways. For example, a rotating valve spindle may be used to control fluid flow through the nozzle assembly. In another instances, a sliding gate may be used. Other configurations are possible.

the nozzle assembly or valve gate may provide visual indicia to readily indicate to an operator whether the valve gate is in an open or closed position.

the valve gate may be designed to accommodate variable flow from two or more distinct fluid chambers.

the valve gate may be made from a material having different operational characteristics from the other materials of construction used in other portions of the nozzle assembly. For example, the valve gate may be made of Teflon™ or other low-stick materials to inhibit seizure of the valve gate within a valve housing.

the valve assembly may be removable for cleaning and reuse.

these and other advantages may be available to those who use embodiments of the present invention.

The foregoing are only some examples of certain embodiments of the invention. Many other embodiments, variations and derivations will become apparent from a review of the entire description, including the appended drawings.

### IN THE DRAWINGS

Certain specific embodiments of the invention will be described with reference to the following drawings in which:

FIG. 1A is an exploded side view, in partial section, of a first embodiment of the invention.

FIG. 1B is an exploded side view, in partial section, of a second embodiment of the invention.

FIG. 1C is an exploded side view, in partial section, of a third embodiment.

FIG. 2 is an exploded side view, and a partial sectional view of a fourth embodiment.

FIG. 3 is an exploded side view, and a partial sectional view of a fifth embodiment.

FIG. 4 is an enlarged side view, in partial section, of a sixth embodiment of the present invention.

FIG. 5 is an enlarged side view, in partial section, of a seventh embodiment.

FIG. 5A is an enlarged perspective end view of a component of the embodiment shown in FIG. 5.

FIG. 6 is a side view, in partial section, of an embodiment of the invention, installed within a dispensing device.

FIG. 6A is a side view, in partial section, of the embodiment of FIG. 6, installed in another dispensing device.

FIG. 7A is an exploded view, in partial section, of an eight embodiment.

FIG. 7B is a side view of the valve spindle of the embodiment in FIG. 7A, wherein the valve spindle is in the open position.

FIG. 7C is a side view, in partial section, of a cylinder housing of a dispensing device suitable for use with the embodiment of FIG. 7A.

FIG. 8 is a side view, in partial section, of a ninth embodiment of the invention.

FIG. 9 is a side view of a base of a nozzle assembly fitted with an optional reclosure cap.

FIG. 9A is a side view of a detachable nozzle piece, fitted with an optional reclosure cap.

FIG. 10A is a side view, in partial section, of a tenth embodiment of the invention.

FIG. 10B is a side view of an optional cleaning tool.

FIG. 10C is a front end view of the optional cleaning tool of FIG. 10B.

FIG. 10D is a rear end view of the optional cleaning tool of FIG. 10C.

FIG. 11 is a side view, in partial section, of an optional cutting tool.

FIG. 12A is a side view, in partial section, of an eleventh embodiment of the invention, for use in connection with a two-component container.

FIG. 12B is an end view in perspective, of the two-compartment container shown in FIG. 12A.

FIG. 12C is an end view, in perspective, of a seal shown in association with the embodiment shown in FIG. 12A.

### DETAILED DESCRIPTION OF CERTAIN EMBODIMENTS OF THE INVENTION

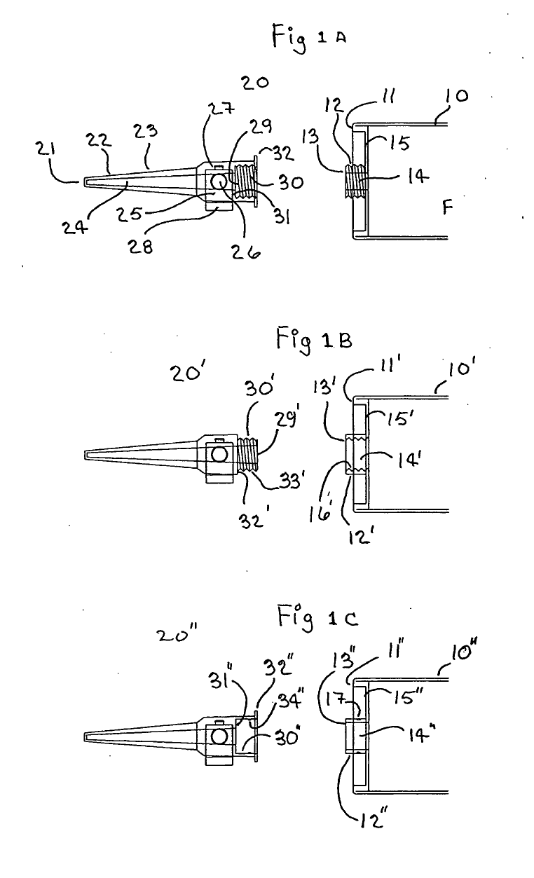

In FIG. 1A, a nozzle assembly 20 is shown disassembled from a tube 10 containing a viscous, flowable material F, such as caulking.

Tube 10 comprises an outwardly projecting shoulder 11 which forms a rim about front wall 15 of tube 10. A threaded stem 12 projects outwardly from front wall 15. Threaded stem 12 terminates at end 13, and defines an outlet bore 14 defining a fluid communication path with fluid contents F in tube 10. Nozzle assembly 20 is configured to securely fasten to threaded stem 12 by threaded engagement between nozzle mounting threads 30 and corresponding threads on threaded stem 12. The base of the nozzle assembly 20 includes mounting flange 32 which projects radially, outwardly from the longitudinal axis of the nozzle assembly 20. When the nozzle assembly 20 is securely fastened to threaded stem 12 of tube 10, it is preferable that end 13 abut against inner shoulder 31 of the nozzle base. Similarly, it is preferred that the mounting flange 32 abut against front wall 15 to further re-enforce front wall 15 against excessive deflection or movement when the fluid contents F are pressurized. The base of nozzle assembly 20 defines a spindle housing 27. Spindle 25 is retained with spindle housing 27 and is permitted to rotate so that the through bore, which defines spindle channel 26, may be moved between open and closed positions. In the closed position, spindle channel 26 is oriented transversely to the internal, tapered cavity 24 extending along the longitudinal axis of the nozzle assembly 20. In the closed position, spindle 25 prevents fluid communication between tapered cavity 24 and bore 14 of tube 10. Entrance cavity 29 defines a closable opening to a fluid flow path along the longitudinal axis of the nozzle assembly 20. Rotatable spindle 25 is moved between open and closed positions via spindle driver 28. Spindle driver 28 may be connected to an actuator assembly in a caulking gun or other suitable dispensing device. Upon rotation of spindle 25 about its rotational axis, spindle channel 26 may be oriented in a plurality of partially, offset positions to impart variable flow rates of fluid F travelling between the interior chamber of tube 10 and nozzle tip 23 of nozzle assembly 20. In a preferred embodiment, the tapered nozzle assembly 20 is provided to the user with a closed end 21 forming a removable, closure at the dispensing end of nozzle tip 23. Premarked cut lines 22 may be provided to suggest appropriate points at which closed end 21 may be cut away from nozzle assembly 20, to form a dispensing outlet to nozzle tip 23. As more of the closed end 21 is cut away from the nozzle tip 23, a larger dispensing outlet is formed, to permit a wider bead of dispensed material to flow through tapered cavity 24.

In an alternative embodiment, the base of nozzle assembly 20′ is shown in FIG. 1B. Mounting flange 32′ extends outwardly from the base of nozzle assembly 20′. Base stem 33′ is provided with outer, mounting threads 30′ to allow secure engagement of the base of the nozzle assembly 20′ with inner, threaded stem 12′ projecting outwardly from front wall 15′ of container tube 10′. Upon threaded engagement of threaded base stem 33′ with threaded stem 12′, mounting flange 32′ also abuts against front wall 15′ of tube 10′. Entrance cavity 29′ defines a fluid flow channel in communication with the contents of tube 10′. In yet a further embodiment illustrated in FIG. 1C, the modified base of nozzle assembly 20″ includes an outwardly projecting mounting flange 32″ that will abut against front wall 15″ of tube 10″ when the base of nozzle assembly 20″ is securely fastened to tube 10″. The interior wall 30″ of the base comprises an inwardly projecting retainer wall 34. Retainer wall 34 is configured to securely engage a mounting channel 17 extending about the periphery of mounting stem 12″. When the nozzle assembly 20″ is brought together in mounting engagement with mounting stem 12″, retainer wall 34 is initially deformed by contact with outer end 13″ of mounting stem 12″. Upon further engagement, retainer wall 34 relaxes and snaps into retaining channel 17 to form a snap-on engagement. Upon full engagement between nozzle assembly 20″and mounting stem 12″, outer end 13″ of mounting stem 12″ abuts against inner shoulder 31″whereas mounting flange 32″ abuts against front wall 15″ of tube 10″.

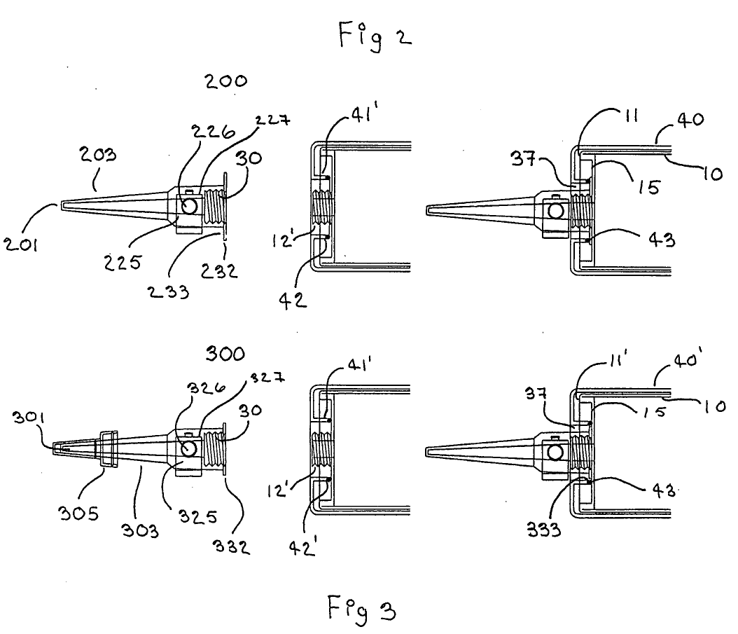

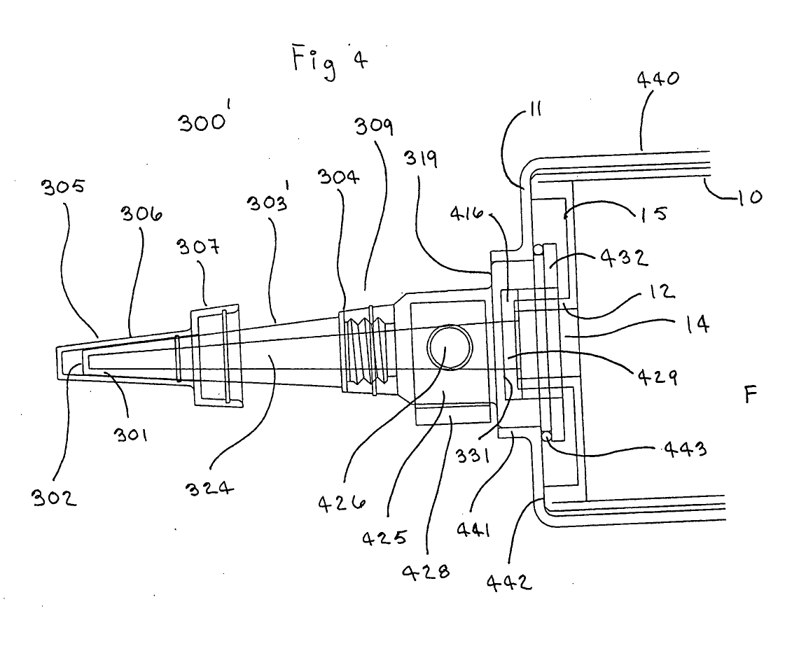

With reference to FIG. 2, a nozzle assembly 200 is shown securely mounted on tube 10. Tube 10 is secured within the interior of a cylinder housing 40. Tube 10 comprises a front wall 15 bounded by shoulder 11 projecting outwardly about the periphery of front wall 15. The base of the nozzle assembly 200 includes an extended, outwardly projecting mounting flange 232 which abuts against front wall 15. Nozzle mounting threads 30 are securely engaged with corresponding threads on threaded stem 12. Cylinder housing 40 defines a nozzle end having inwardly projecting rim 41 which defines a seat 42 for an O-ring 43. In the illustrated embodiment, O-ring 43 forms a gas-tight seal to prevent escape of pressurized gas from the interior of the cylinder housing when the dispensing device is in use. O-ring 43 is compressed snugly against mounting flange 232 . In an alternative embodiment (not shown) inwardly projecting rim 41 may include a uniform ridge (not shown) extending about the periphery of the rim 41. The ridge will extend away from the shoulders of the rim 41, so that when the mounting flange 232 is firmly positioned against rim 41, the ridge will score the surface of flange 232, to form a self-seating seal to prevent pressurized gas from escaping from within the dispensing device. In yet other embodiments, the self-sealing feature may be a similar ridge to score the front wall of the tube. Other sealing features may also be used. Nozzle port 37 is formed at the nozzle end of the cylinder housing 40. Nozzle assembly 200 projects upwardly through port 37. Nozzle assembly 200 comprises a rotating valve spindle 225 mounted within spindle housing 227. Nozzle assembly 200 further comprises nozzle tip 203 terminating at nozzle end 201. When the operator is ready to dispense flowable fluid, a portion of nozzle end 201 is cut away to expose the interior channel of nozzle tip 203 to permit fluid flow through the nozzle tip. Valve spindle 225 may be rotated within the spindle housing 227 upon movement of the spindle between the closed and open positions. The valve spindle 225 may be positioned in a plurality of settings to permit variable flow rates through the nozzle. In this embodiment, extended mounting flange 232 is sufficiently large so that flange end 233 is sufficiently long to extend beyond rim 41 of the cylinder housing 40. Extended flange 232 is of sufficient size to provide an adequate contact surface to firmly seat O-ring 43 to seal the interior of the cylinder housing against accidental escape of pressurized gas.

In FIG. 3, another embodiment of the nozzle assembly is illustrated in which a reduced mounting flange 332 extends within nozzle port 37′ defined by the nozzle end of the cylinder housing 40′ of a dispensing device. Flange end 333 extends in close proximity to inwardly projecting mounting rim 41′ cylinder housing 40′. Rim 41′ defines a seal seat 42′ extending about rim 41′. O-ring 43 extends about the circular seal seat 42′ to form a gas-tight seal between seal seat 42′ and front wall 15 of tube 10. Preferably, flange 333 extends sufficiently outwardly to closely abut against rim 41. Mounting flange 332 snugly abuts against front wall 15 to further reinforce front wall 15 against distortion or deflection when the contents of the tube are subjected to increased operating pressures. Rotating valve spindle 325 is mounted within spindle housing 327 of nozzle assembly 300. Nozzle assembly 300 defines a nozzle tip 303 terminating in the dispensing end 301. When the dispensing end is opened by cutting or other suitable means, an opening is provided to dispense flowable fluid when the valve spindle is moved to an open position. A reclosure cap 305 may be fastened to cover the exposed opening at nozzle end 301.

In one aspect, the nozzle assembly is preferably made of a rigid, inexpensive material such as thermoplastic. In other instances, it may be desirable to include components made from different materials. By way of example, in certain instances, it may be desirable to inhibit sticking or seizure of the valve spindle within the spindle housing. As an example, the valve spindle may be made of Teflon™ or other material selected to allow free rotational movement of the spindle within the spindle housing. By way of example, Teflon™ or other materials may be selected for their compatibility with other materials of construction and dispensable fluids. For example, certain thermoplastics are less prone to sticking or seizure when used in connection with certain types of dispensable fluids such as adhesives. In other instances, one or more components may be made from metal, alloys, or other resilient, corrosion-resistant, rigid materials. In many instances, certain embodiments of the nozzle assembly will be made from inexpensive, thermoplastic materials having suitable performance characteristics to satisfy the needs of the particular applications in which they will be used. Often, other nozzle assemblies made of inexpensive thermoplastic materials will be sufficiently inexpensive permitting users to throw away the nozzle assemblies after a single use, or if an assembly is damaged or rendered unusable due to clogging or other obstructions.

In other embodiments, the nozzle assembly may be designed for removable engagement with one or more caulking tubes or other containers for flowable, viscous materials. That is, certain embodiments of the nozzle assembly may be designed for reuse for extended periods of time, and with different types of dispensing containers.

In certain embodiments, the nozzle assembly will comprise a unitary body cast, molded or otherwise formed from a single work piece. The nozzle body may include a nozzle tip, a housing for a movable valve component such as a spindle or other gate and a mounting base. In other embodiments, the nozzle assembly may have a nozzle body made up of two or more interconnecting parts or components. For example, a modified nozzle body may have a mounting base designed to secure the base to a mounting stem on a caulking tube or other container. The mounting base will define a mounting end with which it will be secured to the mounting stem of the caulking tube. At the opposite end of the mounting base, an interchangeable nozzle tip may be secured. The interchangeable nozzle tip may also be provided with a corresponding cap to reclose the opening at the dispensing end of the nozzle tip. Of course, other multiple component variations of the nozzle assembly will also be possible. For example, the interchangeable nozzle tip component may be removable so that an alternative nozzle tip may be replaced for use within the nozzle assembly. Interchangeable nozzle tips may be provided with different, dispensing openings capable of extruding beads of different shapes and sizes. For example, the nozzle tip openings may come in a range of opening sizes capable of dispensing beads of different diameters and shapes. By providing interchangeable tips, an operator will not be required to cut or shape the nozzle tip to obtain a particular nozzle opening size.

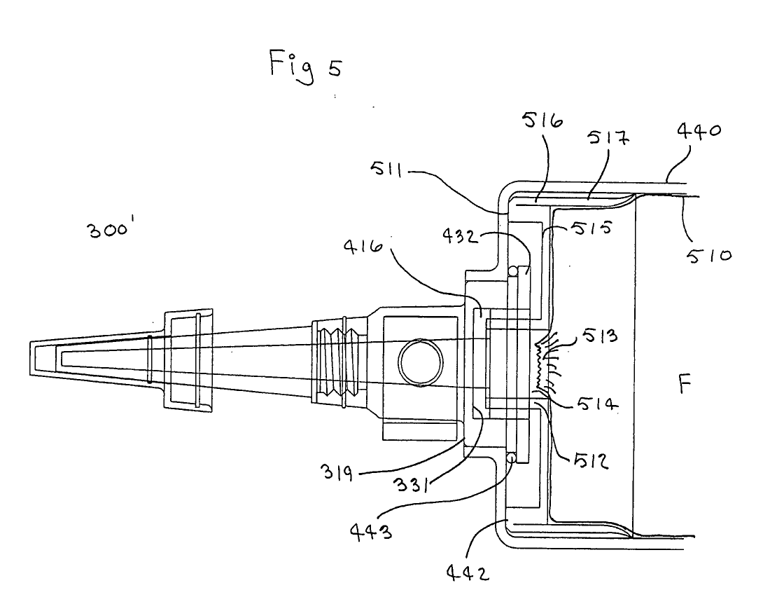

With reference to FIGS. 4 and 5, a nozzle assembly 300′ is securely mounted in fluid communication with the contents of a tube 10. Nozzle assembly 300′ includes a nozzle base 319. Nozzle base 319 defines an outwardly projecting mounting flange 432 which projects outwardly, a sufficient distance to provide a seating surface for an O-ring 443. When mounted, the mounting flange 432 abuts against front wall 15 of tube 10. Shoulder 11 of tube 10 also abuts against the inner surface of housing end wall 442. Housing 440 of the dispensing device defines outwardly projecting rim 441 which in turn defines a housing for the nozzle base 319. Mounting stem 12 of tube 10 defines a bore 14 which functions as an outlet for flowable fluid F contained within tube 10. Bore 14 is in fluid communication with entrance cavity 429 within nozzle base 319. When valve spindle 425 of the nozzle assembly 300′ is rotated to an open position, spindle opening 426 permits fluid communication between the contents of tube 10 and tapered cavity 324 of replacement nozzle tip 303′. Valve spindle 425 may be moved between open and closed positions by operative movement of spindle driver 428. Spindle driver 428 is connected to an actuator assembly (not shown) on the dispensing device. A further seal 416 is provided between mounting stem 12 and inner shoulder 331 in nozzle base 319. Seal 416 inhibits escape of pressurized gas from within the interior of the cylinder housing 440. O-ring 443 also inhibits accidental escape of pressurized gas from the interior of the cylinder housing 440. In the embodiment as illustrated in FIGS. 4 and 5, valve spindle 425 is oriented in a closed position so that spindle channel 426 is not aligned with the interior channel of the nozzle assembly 300′. In the illustrated embodiment, a replaceable nozzle tip 303′ is provided. The replaceable nozzle tip 303′ includes a nozzle tip mounting base 304 which may be securely fastened to connector portion 309 of nozzle base 319. Nozzle tip mounting base 304 and connector portion 309 may be suitably threaded with other connective features for secure engagement of the replaceable nozzle tip to the nozzle base. The replaceable nozzle tip 303′ defines a nozzle end 301 ending at dispensing opening 302. A complimentary reclosure cap 305 is shown snugly fit over nozzle end 301, in removable engagement. Reclosure cap 305 defines a first cap portion 306 which is configured to snugly engage nozzle end 301 to inhibit air communication with the contents of the tapered cavity 324. Reclosure cap 305 is also provided with a second cap portion 307 which is configured to snugly engage nozzle tip mounting base 309 when the replacement nozzle tip 303′ is disconnected from the nozzle assembly. A two-part reclosure cap may be advantageous in those instances where it is desirable to reclose the nozzle base between dispensing operations. With reference to FIG. 5, nozzle assembly 300′ is shown in operation in association with a dispensing device containing a sausage-type container of dispensable fluid F. The sausage container 510 is positioned within the interior of cylinder housing 440 of the dispensing device. At the dispensing end of the sausage 510, an opening 513 is provided in the sausage wall. Opening 513 permits fluid communication with bore 514 defined within mounting stem 512 of adapter cap 516. Adapter cap 516 may be made of molded flexible plastic material or other materials suitable for use in the particular application. (Front wall 515 of adapter cap 516 does not abut against mounting flange 432 of the nozzle assembly.) Shoulder 511 of adapter cap 516 abuts against the interior of housing end wall 442. O-ring 443 is firmly seated between mounting flange 432 of the nozzle assembly and the interior of housing end wall 442. Additional seal 416 is firmly positioned between interior shoulder 331 of the nozzle base 319 and the terminal end of mounting stem 513 of adapter cap 516. O-ring 443 and additional seal 416 are provided to inhibit escape of pressurized gas from within the interior of cylinder housing 440.

With reference to FIG. 5A, adapter cap 516 is shown in isolation from the nozzle assembly and cylinder housing 440 of a dispensing device assembly shown in FIG. 5. Adapter cap 516 is shown in perspective to illustrate the features of the adapter cap. An adapter cap of this type may used as an optional insert within the interior of the cylinder housing 440 to protect the interior nozzle end of the cylinder housing from being dirtied, or fouled with excess fluid F when a partially used sausage 510 is removed from the interior of the cylinder housing 440. Outer wall 517 of adapter cap 516 will be configured to fit snugly within the interior of cylinder housing 440.

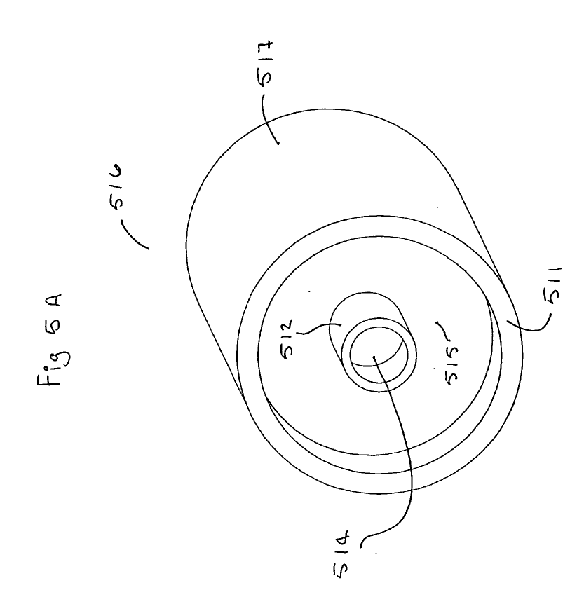

In some embodiments, it may be preferable to slide-fit the nozzle base 319 within the nozzle housing defined by outwardly projecting rim 441. Mounting flange 432 will be sufficiently strong to prevent the nozzle assembly from dis-engaging from the housing 440 when the interior of the housing is pressurized. After the contents are depressurized, and it is desired to remove the spent sausage, and the cap and nozzle assembly from the interior of cylinder housing, the nozzle assembly may be pushed inwardly into the interior of the cylinder housing along with the cap and spent sausage, for ultimate removal at the opposite end of the cylinder housing 440. For example, the spent sausage and nozzle assembly may be removed at the loading end 7 of the dispensing device (as shown in FIGS. 6 and 6A).

FIG. 6 illustrates a nozzle assembly 300′ mounted within a cylinder housing 440 as partially illustrated in FIG. 4. Nozzle assembly 300′ is positioned at the dispensing end 6 of cylinder housing 440. At the opposite, loading end 7 of the cylinder housing 440, a chamber cap 600 is shown in a secured, closed position. Chamber cap 600 may be removed at the appropriate time to load the cylinder housing, or remove its contents. In FIG. 6A, nozzle assembly 300′ is shown assembled in association with cylinder housing 440, having at its loading end 7 a modified chamber cap 620. Modified chamber cap 620 is elongated to provide an extended chamber to contain an extra long caulking tube 610 or other container for dispensable fluid.

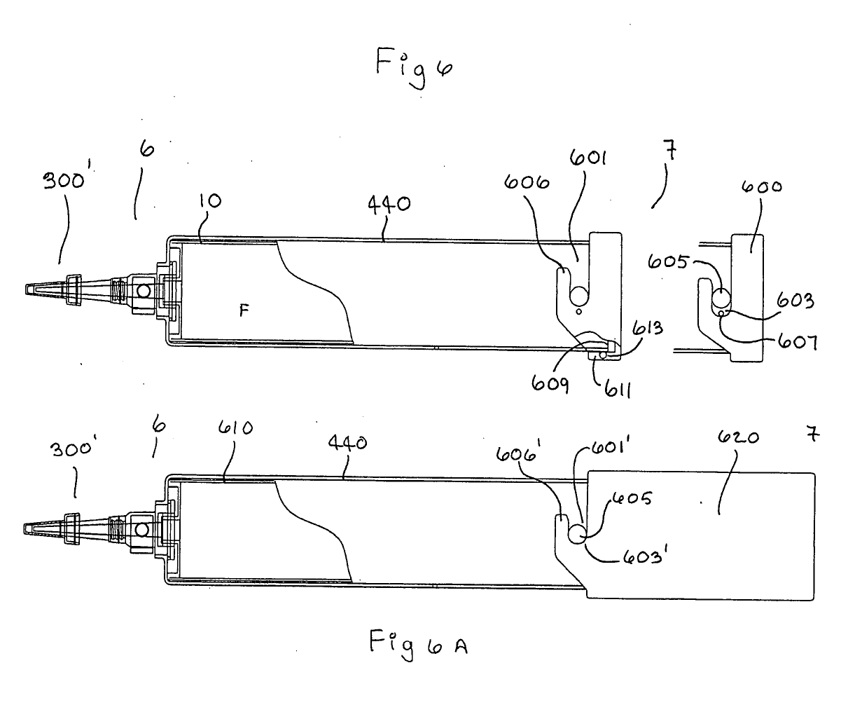

FIGS. 7A, and 7C illustrate a disassembled nozzle assembly 300′ (FIG. 7A), illustrated separately from a cylinder housing 440 containing the caulking tube 10 (FIG. 7C). FIGS. 7A and 7C further illustrate the nozzle assembly and cylinder housing of the embodiment shown in FIG. 6 (and partially shown in FIG. 4). With reference to FIG. 7A, reclosure cap 305 is provided with a first retainer groove 706′ for corresponding engagement with a first retainer 706 on replacement nozzle tip 303′. The second portion 307 of reclosure cap 305 is provided with a retainer groove 705′ for corresponding engagement with a second retainer 705 which projects outwardly from nozzle tip mounting base 309. Reclosure cap 305 is capable of snap-on engagement with either the replacement nozzle tip 303′, to cover nozzle end 301, or to engage the nozzle tip mounting base 309 to cover opening 310′. In FIG. 7A, valve spindle 425 is shown oriented in a closed position. That is, spindle channel 426 has been rotated to prevent fluid communication through the interior channel of the nozzle assembly. In FIG. 7B, valve spindle 425 is shown in a fully opened orientation so that tapered spindle channel 426 aligns with the tapered interior channel of nozzle assembly 300′. In some embodiments, it may be preferable to provide a constant taper throughout the length of the interior channel of the nozzle assembly. An interior channel having a constant taper will, among other things, be easier to clean with an appropriate tapered cleaning tool. In the valve spindle 425 illustrated in FIG. 7A and FIG. 7B, spindle driver 428 may be configured to visually indicate to the operator when it is in the fully closed and fully opened positions.

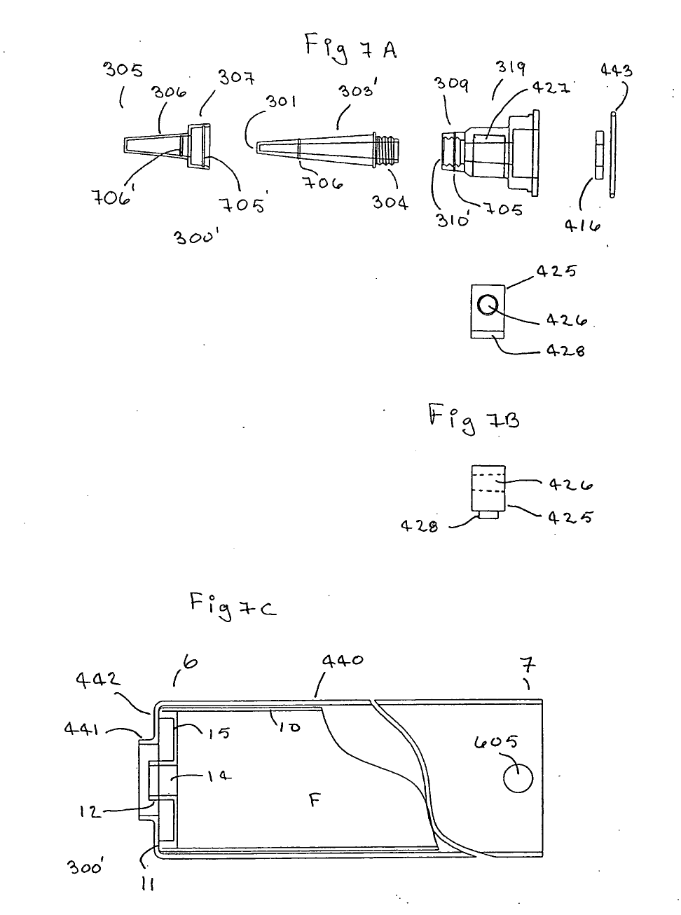

FIGS. 8 and 9 illustrate a modified version of the nozzle assembly in which a retainer O-ring 480 is positioned within complimentary, opposing grooves on valve spindle 425 and the interior wall of spindle housing 427. Retainer O-ring 480 provides an air tight seal to inhibit the entry of air into the interior channel of the nozzle assembly 300′. Retainer O-ring 480 may also act to prevent accidental withdrawal of valve spindle 425 from its properly seated position within spindle housing 427. FIGS. 9 and 9A further illustrate the two-part reclosure cap 305 in which the first portion 306 is used to reclose the dispensing end of the nozzle tip 303′. In FIG. 9, reclosure cap 305 is shown engaged with nozzle tip mounting base 309. Specifically, the second portion 307 of reclosure cap 305 engages base 309.

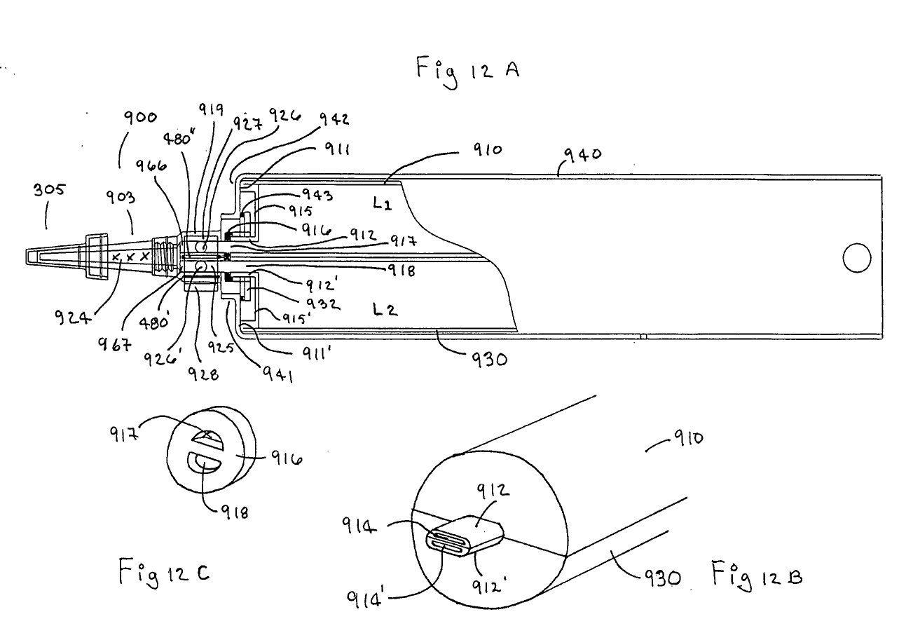

FIG. 12A shows a modified nozzle assembly 900 assembled for use in association with a twin-chambered tube comprising an upper chamber 910 and a lower chamber 912, contained within modified cylinder housing 940 of a modified dispensing device. Nozzle assembly 900 includes a replaceable nozzle tip 903 which defines an interior, tapered mixing zone 924. The nozzle assembly includes a nozzle base 919 which is slide-fit within the chamber formed by rim 941 of cylinder housing 940. An O-ring 943 forms a gas tight seal between front wall 942 of cylinder housing 940 and retainer flange 932 which projects outwardly from nozzle base 919. Upper tube 910 contains a first flowable fluid L1 which may flow outwardly from the interior of tube 910, when subjected to pressure. Fluid L1 will travel through upper bore 914, and through channel portion 917 defined by the upper portion of seal 916. The fluid contained within lower tube portion 912′ (identified as fluid L2) will flow outwardly from lower tube 930 when the contents are subjected to pressure. Fluid L2 will exit from lower tube 930, through lower bore 914′, and thereafter through channel segment 918 defined by the lower portion of seal 916. Seal 916 forms a gas-tight seal between upper stem 912 and a corresponding portion of the interior of nozzle base 919, and between the lower stem 912′ and its corresponding portion of the interior of nozzle base 919. O-ring 943 and seal 916 are provided to inhibit the escape of pressurized gas from the interior of cylinder housing 940. In some instances, it will be desirable to dispense a multi-component fluid mixture in a manner that would provide intimate mixing of the fluid components within the interior of the nozzle assembly so that after mixing, the resulting mixture is dispensed at the opening of the nozzle assembly. For example, two-component fluids may be stored in separate containers until it is desired to dispense a mixture of those components and apply the mixture to the desired target areas. In the illustrated embodiment, the modified valve assembly 900 includes a modified valve spindle 925 having an upper spindle channel 926 and a lower spindle channel 926′. In the illustrated position, the valve spindle 925 is shown in the fully closed position. In the illustrated embodiment, a pair of parallel retainer O-rings 480″, 480′ are seated within opposing pairs of matching grooves on the interior of the spindle housing 927 and valve spindle 925. Lower retainer O-ring 480′ is provided to inhibit air from entering into the valve assembly. Upper retainer O-ring 480″is also provided to prevent accidental mixing of fluid components L1, L2 which might otherwise tend to flow and mix along existing gaps between valve spindle 925 and spindle housing 927. When valve spindle 925 is moved to an open position by operative action on spindle driver 928, upper spindle channel 926 aligns with upper bore 914, channel segment 917, and exit channel 966 to permit fluid L1 to enter into mixing zone 924. Similarly, when lower spindle channel 926′ is aligned in an open position with the valve assembly, fluid L2 will flow through lower bore 914′, though lower channel segment 918, through lower spindle channel 926′, through lower exit channel 967 and into mixing zone 924. Upon traveling toward the dispensing end of the nozzle assembly, fluids L1 and L2 are intimately mixed and thereafter discharged from the tip of nozzle assembly. In multi-component systems, the two or more components may be mixed in unequal proportions. To accommodate different proportions of the components, the relative diameters of the corresponding component flow paths may be adjusted to obtain the desired proportions.

In the illustrated embodiment, a reclosure cap 305 is shown placed over the open end of replaceable nozzle tip 903. In certain instances, a reclosure cap 305 will not prevent curing of the mixture or material contained within mixing zone 924. Where the mixed contents of the mixing zone 924 have cured, rendering the nozzle tip 903 unusable, the nozzle tip 903 may be removed and thereafter replaced with a clean, substitute nozzle tip 903. In another instances, it may be necessary to replace the entire nozzle assembly if the interior passage ways are plugged with cured portions of fluids L1 and L2.

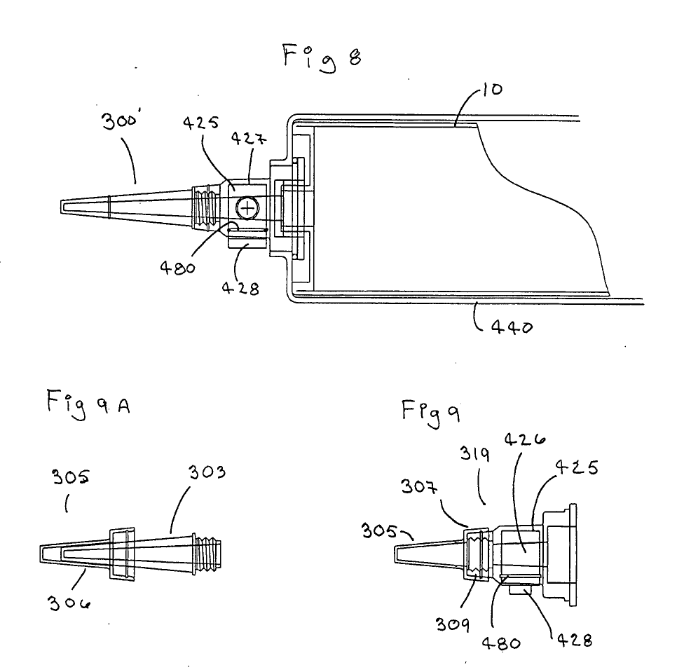

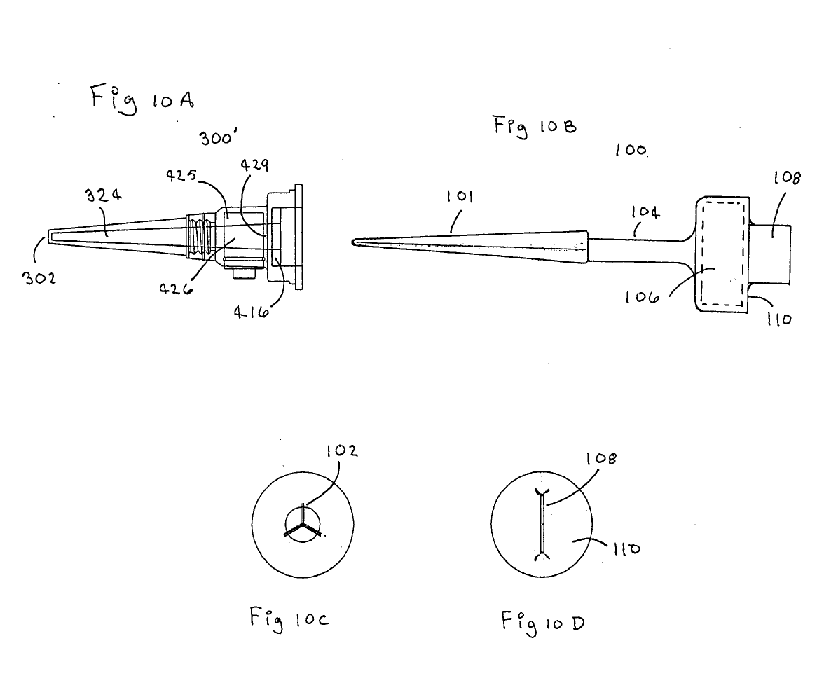

FIGS. 10A, 10B, 10C and 10D illustrate the features of one embodiment of a cleaning tool 100 shown in aligned orientation with the nozzle assembly 300′. In FIG. 10A, the valve assembly is shown with spindle channel 426 aligned in the fully opened position, thereby providing a continuous interior channel of constant taper extending from dispensing end 302 to seal 416. The interior channel includes tapered cavity 324, spindle channel 426, entrance cavity 429 and a bore extending through seal 416. When the valve spindle 425 is aligned in the fully opened position, blade portion 101 of cleaning tool 100 may be inserted into the continuous, tapered channel within the interior of the valve assembly 300′. Preferably, the taper of the blade portion 101 matches the taper of the interior walls of the interior channel extending along the nozzle assembly. In the illustrated embodiment, blade portion 101 includes three blade portions 102 which may be used to scoop out any remaining material to unplug the interior channel of the nozzle assembly. The blade portion 101 is inserted into the interior channel of the nozzle assembly until the edges of the blade portions 102 fully engage with the interior walls of the interior channel of nozzle assembly 300′. Cleaning tool 100 is provided with a hollow handle 104 surrounding the hollow interior 106. Flange 108 extends from a base 110. The flange 108 and base 110 define a finger grip to exert torque, for rotational movement of the cleaning tool and its blades within the interior channel of the nozzle assembly.

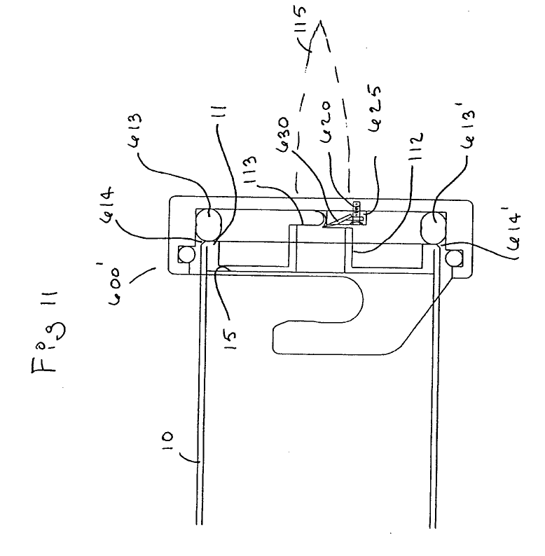

In some instances, a caulking cartridge 10 or other container may come with a pre-attached, elongated nozzle made of a thermoplastic material or other material which may be cut and trimmed. For example, many cartridges used for sealants, including, caulking, adhesives, and other dispensable, viscous materials are provided with such pre-attached, hollow nozzles. In FIG. 11, such a cartridge 10 is originally provided with an elongated nozzle piece 115. The nozzle 115 may be cut by the user to an intermediate length represented by pre-cut end 113. The remaining, hollow stem portion 112 may be trimmed to a pre-selected, desired length by rotational engagement with a knife 630 securely mounted within a modified chamber cap 600′.

In the illustrated embodiment, chamber cap 600′ includes knife 630 secured with a mounting screw 620, to a knife base 625. The interior edge 614 of an O-ring 613′ (positioned within the cap) will act as a stop when it is in abutting relation to shoulder 11 of cartridge 10. Edge 614 of O-ring 613′ will abut against shoulder 11 to prevent knife 630 from removing an excessive amount of stem material from end 113, leaving a desired, pre-determined length of the stem 112. The cartridge 10 with its threaded stem 112 may then be inserted into the interior of a cylinder housing of a dispensing device, and the threaded stem 112 will then be engaged with a suitable nozzle base of a nozzle assembly. If the stem 112 does not have external threads, the base of the nozzle assembly may be provided with self tapping threads (not shown) or other features to secure the nozzle assembly to the cartridge 10. In some embodiments, it will be particularly important to ensure that the stem on the cartridge is cut to a required length, to ensure a suitable and secure fluid connection with the nozzle assembly. Although the foregoing example described a knife mounted within a chamber cap, similar pre-set cutting and trimming features may be included within another component of the dispensing device (not shown) or as a separate tool (not shown) which may be included in a nozzle assembly installation kit.

The foregoing are examples of certain aspects of the present invention. Many other embodiments, including modifications and variations thereof, are also possible and will become apparent to those skilled in the art upon a review of the invention as described herein. Accordingly, all suitable modifications, variations and equivalents may be resorted to, and such modifications, variations and equivalents are intended to fall within the scope of the invention as described herein and within the scope of any issued patent claims.

We claim:

1. A nozzle for use in a hand held dispensing device for viscous fluid, the nozzle comprising:
an elongated body extending along a longitudinal axis and defining a path for fluid communication between a dispensing end of the nozzle and a base;
a variable flow valve operating along a range of positions between a closed position and an open position, within a preformed housing extending transversely through the fluid path;
the base comprising a first coupling to secure the nozzle relative to the dispensing device; and
a second coupling for associating operation of the valve with a hand operated control positioned remotely on the dispensing device.

2. In the nozzle claimed in claim 1, the valve rotating between the closed and open positions.

3. In the nozzle claimed in claim 1, the valve rotating about an axis intersecting the fluid path.

4. In the nozzle claimed in claim 3, the valve comprising a rotatable spindle defining a rotatable portion of the fluid path.

5. The nozzle claimed in claim 1, comprising a removable tip adjacent the dispensing end, the tip defining a portion of the fluid path remote from the base.

6. The nozzle claimed in claim 5, comprising a replaceable cap to cover a fluid path opening in the nozzle opposite the base.

7. In the nozzle claimed in claim 1, the first coupling being securable to a fluid container, the fluid container being securable relative to the dispensing device.

8. In the nozzle claimed in claim 1, the fluid path defining a tapered channel parallel to the longitudinal axis and extending between the base and the dispensing end of the nozzle opposite the base.

9. In the nozzle claimed in claim 1, the first coupling comprising threading to engage a portion of a fluid container, the fluid container being securable to the dispensing device.

10. The nozzle claimed in claim 1, comprising a funnel to contain a portion of a collapsible fluid container, the collapsible container being securable within the dispensing device.

11. The nozzle claimed in claim 1, defining a second path for fluid communication between the dispensing end and the base.

12. In the nozzle claimed in claim 11, the valve comprising a rotatable spindle defining a rotatable portion of the second fluid path.

13. The noble claimed in claim 1, in operative combination with a dispensing device, the valve operating between the closed position and the open position via the hand operated control.

14. The nozzle in operative combination with the dispensing device as claimed in claim 13, the dispensing device being powered by pressurized gas to dispense the fluid through the dispensing end of the nozzle.

15. The nozzle in operative combination with the dispensing device as claimed in claim 14, the pressurized gas acting on the fluid contained within the dispensing device, upon activation of the hand operated control.

16. A portable hand held dispensing gun comprising:
a housing for a container of viscous fluid contents, the housing extending along a longitudinal axis of the gun, the housing being supported by a handle;
a nozzle comprising:
an elongated body extending along the longitudinal axis and defining a path for fluid communication between a dispensing end of the nozzle and a nozzle base;
a variable flow valve operating along a range of positions between a closed position and an open position, within a preformed second housing extending transversely through the fluid path;
the nozzle base securing the nozzle relative to the gun ; and
a hand activated control positioned on the handle for operating the valve between the closed and open positions, the control co-acting on a portion of the fluid contents to flow through the nozzle when the valve is moved from the closed position.

17. In the dispensing gun claimed in claim 16, the valve rotating about a second axis defined by the second housing when the valve is operating between the closed and open positions, the second axis intersecting the longitudinal axis.

18. In the dispensing gun claimed in claim 17, the nozzle comprising a replaceable nozzle tip, the tip defining a portion of the fluid path extending away from the dispensing gun.

19. In the dispensing gun claimed in claim 18, the nozzle comprising a replaceable cover for a fluid path opening defined by the tip.

20. A kit for a nozzle assembly for use in a portable hand held dispenser of viscous fluid, the dispenser defining a longitudinal axis, the kit comprising:
a nozzle comprising:
a dispensing end opposite a base;
the base comprising a first coupling to secure the nozzle relative to the dispenser;
an elongated body extending along the longitudinal axis and defining a path for fluid communication between the dispensing end and the base;
a variable flow valve rotating through a range of selectable positions between a closed position and an open position, within a preformed housing extending across the longitudinal axis;
and
a second coupling for operatively associating the valve with a hand operated control positioned remotely on the dispenser; and
a replaceable nozzle tip defining a portion of the fluid path extending away from the base.

21. In the kit claimed in claim 20, the nozzle tip being a first nozzle tip interchangeable with one or more other nozzle tips defining fluid path portions differing from the fluid path portion defined by the first nozzle tip.

22. The kit claimed in claim 20, comprising a replaceable end cap to cover an opening of the fluid path portion defined by the nozzle tip.

23. The kit claimed in claim 20, the base comprising an engagement portion to secure the nozzle to a preformed nozzle segment extending from a replaceable container of viscous fluid.

24. The kit claimed in claim 23, the engagement portion comprising threading capable of engaging the preformed nozzle segment.

25. The kit claimed in claim 20, comprising a cleaning tool defining a uniform taper, and the fluid path defining a channel having said uniform taper.

26. An elongated fluid container for use in a hand held dispensing device for viscous fluid, the container comprising:
an elongated hollow tube for containing viscous material;
a nozzle having an elongated body extending along a longitudinal axis and defining a path for fluid communication between a dispensing end of the nozzle and a base;
a variable flow valve operating along a range of positions between a closed position and an open position, within a preformed housing extending transversely through the fluid path;
the base being secured to the tube, the tube being securable to the dispensing device; and
a coupling for associating operation of the valve with a hand operated control positioned remotely on the dispensing device.

27. In the fluid container claimed in claim 26, the base and the tube being made from a single work piece.

28. In the fluid container claimed in claim 26, the path for fluid communication is extendable by providing an opening between the base and the hollow tube.

29. In the fluid container claimed in claim 28, the fluid path is extendable by breaking a seal between the base and the viscous material in the tube.
